(19) United States
(12) Patent Application Publication
(10) Pub. No.: US 2007/0223006 A1
(43) Pub. Date: Sep. 27, 2007

(54) SYSTEMS AND METHODS FOR PERFORMING RAPID FLUORESCENCE LIFETIME, EXCITATION AND EMISSION SPECTRAL MEASUREMENTS

(75) Inventors: Guillermo J. Tearney, Cambridge, MA (US); Brett E. Bouma, Quincy, MA (US); Jason T. Motz, Cambridge, MA (US); Leilei Peng, Quincy, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 11/624,455

(22) Filed: Jan. 18, 2007

Related U.S. Application Data
(60) Provisional application No. 60/760,085, filed on Jan. 19, 2006.

(51) Int. Cl. G01B 11/02

(52) U.S. Cl. 356/498

(57) ABSTRACT

Exemplary systems and methods for obtaining information associated with at least one portion of a sample can be provided. For example, a first radiation can be received and at least one second radiation and at least one third radiation can be provided as a function of the first radiation. Respective intensities of the second and third radiations can be modulated, whereas the second and third radiations may have different modulation frequencies, and the modulated second and third radiations can be directed toward the portion. The photoluminescence radiation can be received from the portion based on the modulated second and third radiations to generate a resultant signal. The signal can be processed to obtain the information which is/are photoluminescence lifetime characteristics and/or a polarization anisotropy of the portion. According to another exemplary embodiment, the photoluminescence radiation can be received and the photoluminescence radiation may be based on wavelengths thereof.

### CROSS-REFERENCE TO RELATED APPLICATION(S)

This application is based upon and claims the benefit of priority from U.S. Patent Application Ser. No. 60/760,085, filed on Jan. 19, 2006, the entire disclosure of which is incorporated herein by reference.

### STATEMENT REGARDING FEDERALLY SPONSORED RESEARCH

The invention was made with the U.S. Government support under Contract No. BES-0086709 awarded by the National Science Foundation. Thus, the U.S. Government has certain rights in the invention.

### FIELD OF THE INVENTION

The present invention relates generally to spectroscopic measurements, and more particularly to system and method for obtaining fluorescent spectroscopic measurements.

### BACKGROUND OF THE INVENTION

In fluorescence spectroscopy, fluorescence lifetime, excitation and emission spectra measurements can significantly enhance the capabilities of conventional fluorescence spectroscopy. Fluorescence spectroscopy techniques can be used to determine chemical composition, conduct investigations of molecular mechanisms, and may be applicable for a non-invasive optical diagnosis. Unfortunately, a majority of spectroscopic devices utilize long acquisition times (e.g., minutes to hours) to obtain these optical signatures. The inability of the conventional technology to obtain these various spectra in real-time can hinder the evaluation of dynamic biological systems.

While many chemical samples may generally have a simple fluorescence spectra, an analysis of complicated biological samples and tissues generally uses the knowledge of the entire intensity-excitation-emission-matrix (“I-EEM”) to facilitate the review of biochemical reactions and disease diagnosis. Conventional methods for obtaining such information may use a complex instrumentation with limited acquisition rates. Further, while spectral intensity measurements may provide important information, these measurements may be highly dependent upon experimental conditions such as excitation/collection geometry and irradiance, and can be subject to certain effects (e.g., quenching and photobleaching that create difficulties for obtaining quantitative results). Fluorescence lifetime measurements may be insensitive to these variables and effects, and can therefore provide a complimentary and more robust method for analyzing a chemical content. In addition, at least certain lifetime measurements may be very sensitive to environmental conditions such as oxygen concentration and pH, and can therefore be used to monitor many types of interactions.

Certain conventional systems which are designed to rapidly obtain a combination of excitation and emission spectra and measure the excitation spectra serially may be typically composed of a complex instrumentation, contain design compromises or imperfections that may limit the resolution of the individual spectra, and still may need hundreds of milliseconds to obtain a complete excitation-emission matrix (“EEM”). A conventional Fourier transform spectrometer has been used in a fast simultaneous acquisition of the excitation and emission spectra. However, a Fourier transform technique of the simultaneous acquisition on the intensity excitation-emission matrix and lifetime has not been described.

Accordingly, it may be beneficial to address and/or overcome at least some of the deficiencies described herein above.

### OBJECTS AND SUMMARY OF THE INVENTION

One of the objectives of the present invention is to overcome certain deficiencies and shortcomings of the conventional systems and methods (including those described herein above), and provide exemplary embodiments of systems and methods for obtaining fluorescent spectroscopic measurements.

For example, according to exemplary embodiments of the present invention, a measurement can be provided. Such exemplary system may include a broadband illumination source, an interferometer that can spectrally modulate the illumination source, and a parallel detection arrangement on the emission spectrum. A device for conducting fluorescence lifetime, excitation, and emission spectral measurement can also be provided. Such exemplary device may be advantageous in that the spectra may be obtained rapidly, use a limited number of detectors, and be significantly smaller than conventional fluorescent spectrometers. Thus, field-based measurements may be performed using such exemplary system. In one exemplary variant, the interferometer can be provided as a Michelson interferometer. Such Michelson interferometer and the Fourier transform arrangement can be used to measure the excitation spectra.

Thus, according to certain exemplary embodiments of the present invention, exemplary systems and methods can be provided for obtaining information associated with at least one portion of a sample. For example, a first radiation can be received and at least one second radiation and at least one third radiation can be provided as a function of the first radiation. Respective intensities of the second and third radiations can be modulated, whereas the second and third radiations may have different modulation frequencies, and the modulated second and third radiations can be directed toward the portion. The photoluminescence radiation can be received from the portion based on the modulated second and third radiations to generate a resultant signal. The signal can be processed to obtain the information which is/are photoluminescence lifetime characteristics and/or a polarization anisotropy of the portion.

According to another exemplary embodiment, the above-described exemplary procedures can be performed by at least one arrangement which may include a particular interferometer arrangement. The particular interferometer arrangement can contain at least one path that is translatable. A further interferometer can be provided which is in communication with the particular interferometer, and may generate a further signal. At least one non-linearity of the signal can be corrected as a function of the further signal. It is also possible to detect a polarization of the photoluminescence lifetime characteristics.

According to another exemplary embodiment, the photoluminescence radiation can be received and the photoluminescence radiation may be based on wavelengths thereof. Such exemplary procedure can be performed by at least one further arrangement which may include a particular interferometer arrangement. The further arrangement can include a grating arrangement. It is also possible for the arrangement and the further arrangement to include the interferometer arrangement and/or a particular interferometer arrangement.

The further arrangement can include includes a detection arrangement which may be configured to perform a parallel detection of spectrum of the photoluminescence radiation. It is also possible to modulate the spectrum of the photoluminescence radiation. In addition, it is possible to process the modulated spectrum to generate an intensity excitation emission matrix of the photoluminescence radiation. Modulation frequencies of the second and third radiations can be modulated to determine a change in the intensity excitation emission matrix. A determination can be made as to a lifetime excitation emission matrix of the photoluminescence radiation based on the change. It is also possible to determine a polarization anisotropy emission matrix of the photoluminescence radiation based on the change. The further arrangement can include a dispersive arrangement.

Other features and advantages of the present invention will become apparent upon reading the following detailed description of embodiments of the invention, when taken in conjunction with the appended claims.

### BRIEF DESCRIPTION OF THE DRAWINGS

Further objects, features and advantages of the present invention will become apparent from the following detailed description taken in conjunction with the accompanying figures showing illustrative embodiments of the present invention, in which:

FIG. 1. is a block diagram of a system according to an exemplary embodiment of the present invention which can include a light source, a first interferometer, a sample under investigation and a second interferometer along with reference light sources for correcting both interferometers' motion nonlinearities;

FIG. 2A is an exemplary graph of illumination cross-correlation amplitude versus time for simulated time traces of detected signals for a case of two fluorophores;

FIG. 2B is an exemplary graph of fluorescence signal amplitude versus time for the simulated time traces of the detected signals for the case of two fluorophores;

FIG. 2C is an exemplary graph of diagonal projection of time domain (“TD”) excitation-emission-matrix (“EEM”) amplitude versus time for the simulated time traces of the detected signals for the case of two fluorophores;

FIG. 3 is an exemplary graph of relative intensity of a diagonal projection of a single-fluorophore EEM versus radians;

FIG. 4 is an exemplary image of illumination mirror position (μm) versus emission mirror position for a simulated time-domain EEM of two fluorophores with overlapping excitation spectra and different emission spectra;

FIG. 5 is an exemplary graph of ωₓ versus ωₘ for recovered intensity-excitation-emission-matrix (“I-EEM”) of two fluorophores with the overlapping excitation spectra and a unique emission spectra;

FIG. 6 is a block diagram of an exemplary embodiment of a Michelson interferometer arrangement containing a stationary mirror and a scanning mirror, and which can be used as the first interferometer and/or the second interferometer in the exemplary system shown in FIG. 1;

FIG. 7 is a block diagram of a system for obtaining the fluorescence excitation spectra and fluorescence lifetimes according to another exemplary embodiment of the present invention which includes an interferometer, a reference illumination detector and a fluorescence detector;

FIG. 8 is a block diagram of a system for obtaining the emission spectra according to still another exemplary embodiment of the present invention which can include at least one Michelson interferometer and/or a spectrometer;

FIG. 9 is a block diagram of a system for obtaining EEM according to yet another exemplary embodiment of the present invention, which can include two Michelson interferometers, a reference illumination detector, and a fluorescence detector;

FIG. 10 is a block diagram of a system for obtaining fluorescence anisotropy EEMs according to a further exemplary embodiment of the present invention which can include a polarizer, two Michelson interferometers, a polarizing beamsplitter and two fluorescence detectors;

FIG. 11 is a block diagram of a system for obtaining a reference measurement to correct for non-linear motion of the scanning mirror in a Michelson interferometer according to an additional exemplary embodiment of the present invention;

FIG. 12 is a block diagram of a system for obtaining absorbance spectral measurements, including a Michelson interferometer, a reference illumination detector and a transmission detector according to a still further exemplary embodiment of the present invention;

FIG. 13 is a block diagram of a system for obtaining diffuse reflectance including a Michelson interferometer, a reference illumination detector, and a reflectance detector according to another exemplary embodiment of the present invention;

FIG. 14A is an exemplary graph of intensity versus scan number for a reference signal;

FIG. 14B is an exemplary graph of mirror position versus scan number;

FIG. 14C is an exemplary graph of intensity versus corrected scan number for a corrected reference signal;

FIG. 14D is an exemplary graph of intensity versus frequency for a reference signal;

FIG. 14E is an exemplary graph of intensity versus frequency for a corrected reference signal;

FIG. 15 is a block diagram of an exemplary embodiment of a system according to the present invention which can use two Michelson interferometers;

FIG. 16 is a block diagram of another exemplary embodiment of the system according to the present invention which can use multiple passes of a single scanning interferometer by including a stationary interferometer (e.g., an etalon);

FIG. 17 is a block diagram of a further exemplary embodiment of the system according to the present invention which can use two interferometers from the same double sided moving element and a step scanning element for one of the interferometers;

FIG. 18 is a block diagram of yet another exemplary embodiment of the system according to the present invention which uses a double-sided mirror and a multi bounce element;

FIG. 19 is a block diagram of yet another exemplary embodiment of the system according to the present invention which can utilize a single interferometer and a spectrometer;

FIG. 20 is a block diagram of an exemplary embodiment of an etalon beamsplitter for multiple passing the scanning interferometer according to the present invention;

FIG. 21 is a block diagram of an exemplary embodiment of an arrangement which can obtain a short lifetime measurement, and which uses high frequency electro or acoustic modulators;

FIG. 22 is a block diagram of an exemplary embodiment of an arrangement which can obtain a short lifetime measurement, and which uses modulated light source and detector; and

FIG. 23 is a block diagram of an exemplary embodiment of an arrangement which can obtain a short lifetime measurement, and which uses pulsed light source and gain modulated detector.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

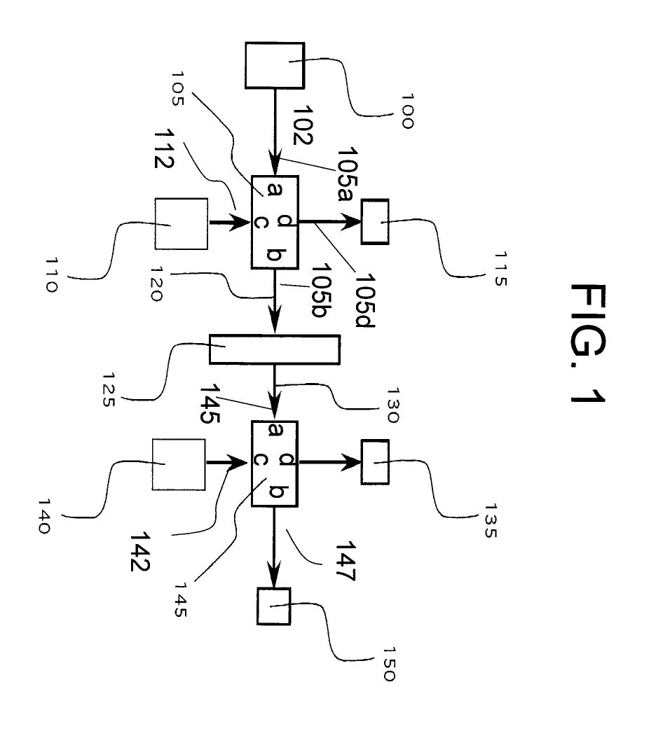

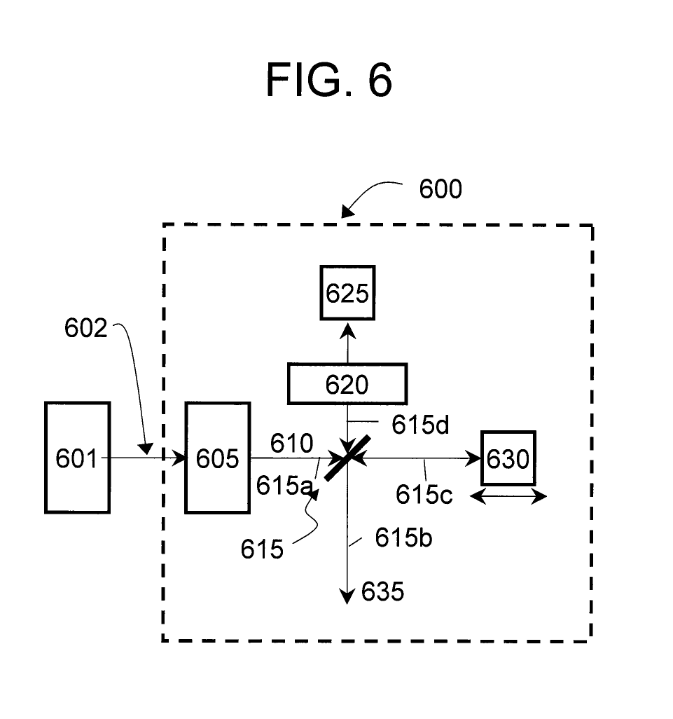

FIG. 1 shows an exemplary embodiment a measurement system/device which can includes a light source 100 coupled to an interferometer at a first port 105a. In one exemplary variant (as described in, e.g., J. G. Hirschberg et al., “Interferometric measurement of fluorescence excitation spectra”, Appl. Opt. 37(10), 1953 (1998)), the interferometer 105 can be provided as a Michelson interferometer which may be the same as or similar to the type described below in conjunction with the exemplary interferometer shown in FIG. 6. According to another exemplary variant, the interferometer 105 may be provided as a Sagnac 3, Mach-Zehnder, Twyman-Green interferometer. Other exemplary interferometric devices can also be used.

A second light source 110 can be coupled to a third port 105c of the interferometer 105 and a fourth port 105d of the interferometer is coupled to a device 115. Third port 105b of interferometer 105 may lead to a sample 125. A second interferometer 145 can be disposed such that light or other electromagnetic radiation emitted from sample 125 may be collected at a second output port 145a of the interferometer 145. The second output port 145b of the interferometer 145 can be coupled to one or more detectors 150. A light source 140 may be coupled to the third port 145a of the interferometer 145, and a fourth port 145d of interferometer 145 may be coupled to a device 135. In certain exemplary embodiments, it may be possible to replace the second interferometer 145 with a spectrometer.

In operation, for example, the source 100 can transmit light 102 into port 105a of the interferometer 105. The input light can be affected by the interferometer 105 so as to produce a spectral modulation on the transmitted light 102. Light 120 emerges from the interferometer port 105b, and illuminates the sample 125 containing fluorescent material. In response to the light 120 impinging thereon, fluorescence within the sample 125 is excited, and the sample 125 emits a fluorescent light 130. The fluorescent light 130 propagating toward the second interferometer 145 can be collected at an interferometer port 145a, and illuminates the second interferometer 145. The second interferometer 145 may be different from or the same as the first interferometer 105. Alternatively, the second interferometer 145 may a different interferometer that can utilize at least some of the components of the first interferometer 105.

Light 147 emerges from the port 145b of the interferometer 145, and may be detected by one or more detectors 150. The detected light can be processed to recover the excitation spectra, emission spectra, intensity excitation-emission matrix (I-EEM), lifetime EEM (L-EEM), and anisotropy EEM's (A-EEM). An additional detector may be used to measure the illuminating light 120 for various calculations. Additional detectors can be utilized to measure the absorption and/or diffuse reflectance spectra of the sample 125 so as to measure the anisotropy spectra and correct for absorption and scattering artifacts in turbid samples.

The light sources 110, 140 can each emit reference light 112, 142 which may be directed to one or more components of the first and/or second interferometers, and utilized to compensate the nonlinearity of a moving component of the interferometers.

According to these exemplary embodiments, in which the second interferometer 145 may be replaced by a grating based spectrometer, the fluorescent light 130 propagating toward the spectrometer may be collected at the spectrometer.

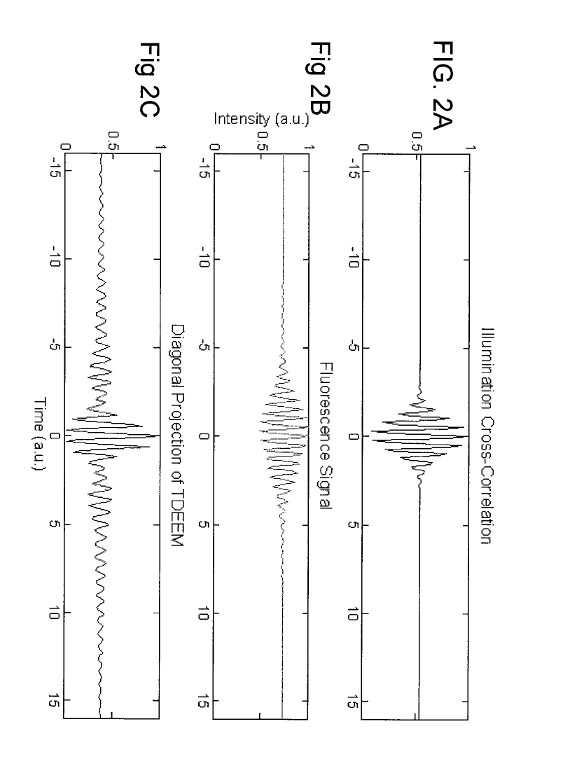

FIG. 2A shows an exemplary graph of illumination cross-correlation amplitude versus time for simulated time traces of detected signals for the case of two fluorophores. FIG. 2B shows an exemplary graph of fluorescence signal amplitude versus time for simulated time traces of detected signals for the case of two fluorophores. FIG. 2C shows an exemplary graph of diagonal projection of TDEEM amplitude versus time for simulated time traces of detected signals for the case of two fluorophores;

Referring to FIG. 2A, a broadband illumination light directed through a Michelson interferometer can be encoded with a wavelength-dependent frequency modulation, which may be detected as the reference illumination signal using the following equation:

$${I}_{I} ( t ) = \frac{1}{2} \int {S}_{I} ( {k}_{I} ) \{ 1 + cos [ 2 {k}_{I} {z}_{X} ( t ) ] \} ⅆ {k}_{I} , \qquad ( 1 )$$

where k_{I}=2π/λ_{I} is the illumination wavenumber, S_{I}(k₁is the illumination spectrum, and z_{X}(t) is the time dependent pathlength difference between the two arms of the first interferometer.

This light can then be incident upon the sample causing fluorescence emission. This exemplary signal (I′_{f}, shown in FIG. 2B) is dependent upon both the fluorescence excitation S_{X}(k_{X}) and emission S_{M}(k_{M} spectra, which can be combined into one term, EEM(k_{X},k_{M} and utilized as follows:

$${I}_{f}^{′} ( t ) = \frac{1}{2} \int \int {S}_{I} ( {k}_{X} ) EEM ( {k}_{X} , {k}_{M} ) \{ 1 + cos [ 2 {k}_{X} {z}_{X} ( t ) - φ ( {k}_{X} , {x}_{M} ) ] \} \partial {k}_{X} \partial {k}_{M} , \qquad ( 2 )$$

where φ(k_{X}, k_{M} contains information about the fluorescence decay lifetime. According to one exemplary embodiment, the relevant signal from the illumination spectrum thus spans, e.g., only the region covered by the excitation spectrum (k_{X}) because fluorescence is only generated where the illumination and excitation spectra overlap. The fluorescence excitation spectrum can be recovered by taking the ratio of the magnitudes of the Fourier transforms of Equations (1) and (2) as follows:

$${S}_{X} ( {k}_{X} ) = \frac{\vert 𝒥 [ {I}_{f}^{′} ( t ) ] \vert}{\vert 𝒥 [ {I}_{I} ( t ) ] \vert} , \qquad ( 3 )$$

since ∫EEM (k_{X}, k_{M})∂k_{M}=S_{X}(k_{X}). The fluorescence lifetime τ(k_{X},k_{M} can be determined as:

$$τ ( {k}_{X} , {k}_{M} ) = \frac{tan [ φ ( {k}_{X} , {k}_{M} ) ]}{2 π f ( {k}_{x} )} , \qquad ( 4 )$$

where f(k_{X})=k_{X}v_{X}/π is the wavelength-dependent frequency modulation, and v_{X} is the mirror velocity.

When this light is directed to the input of a second Michelson interferometer (the system spectrometer), four distinct oscillating terms can be generated to produce the final signal, as follows:

$${I}_{f}^{″} ( t ) = \frac{1}{2} \int \int {S}_{I} EEM \{ \begin{matrix}1 + cos ( 2 {k}_{X} {z}_{X} - φ ) + \\ cos ( 2 {k}_{ M} {z}_{ M} ) + \\ \frac{1}{2} cos ( 2 {k}_{X} {z}_{x} + 2 {k}_{M} {z}_{M} - φ ) + \\ \frac{1}{2} cos ( 2 {k}_{X} {z}_{x} - 2 {k}_{M} {z}_{M} - φ )\end{matrix} \} \partial {k}_{X} \partial {k}_{M} , \qquad ( 5 )$$

where the independent variables have been removed for brevity. FIG. 2C shows an exemplary resultant signal for the case where Z_{X}(t)=Z_{M}(t), which is the Time-Domain (TD) trace of the diagonal EEM projection, e.g., neglecting decay dynamics.

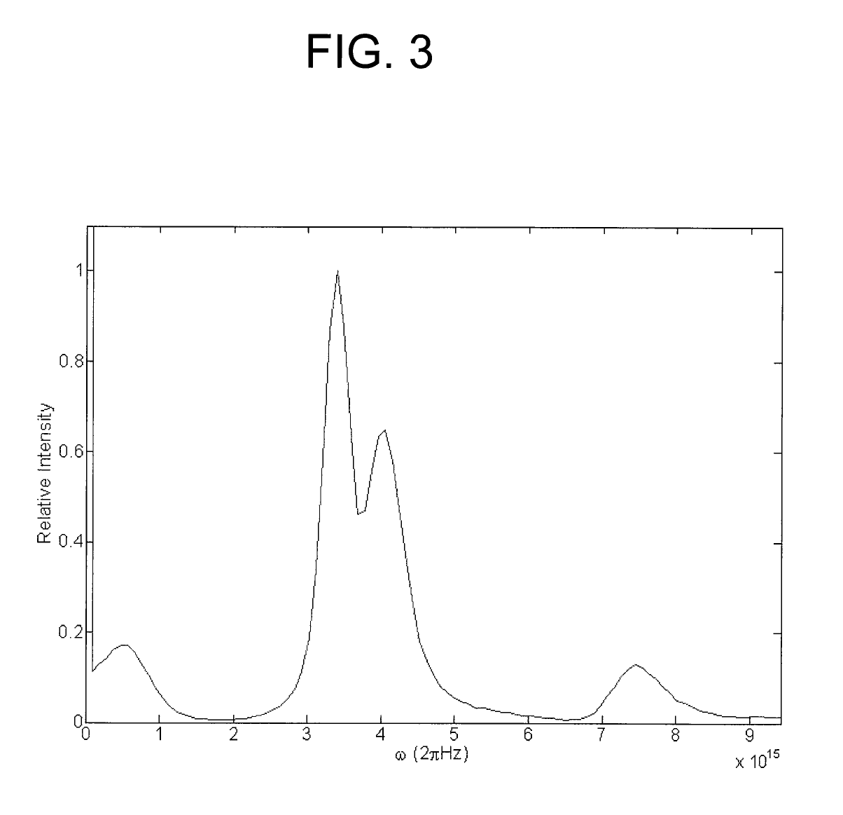

FIG. 3 shows an exemplary graph of a relative intensity of a diagonal projection of a single-fluorophore EEM versus radians. In particular, the Fourier transform of a time trace for a single fluorophore is shown in FIG. 3, where the four separate terms are illustrated. For example, the first oscillatory term of Equation (5) corresponds to the excitation spectrum, the second term to the emission spectrum, and the sum and difference terms provide additional features of the exemplary EEM systems and methods.

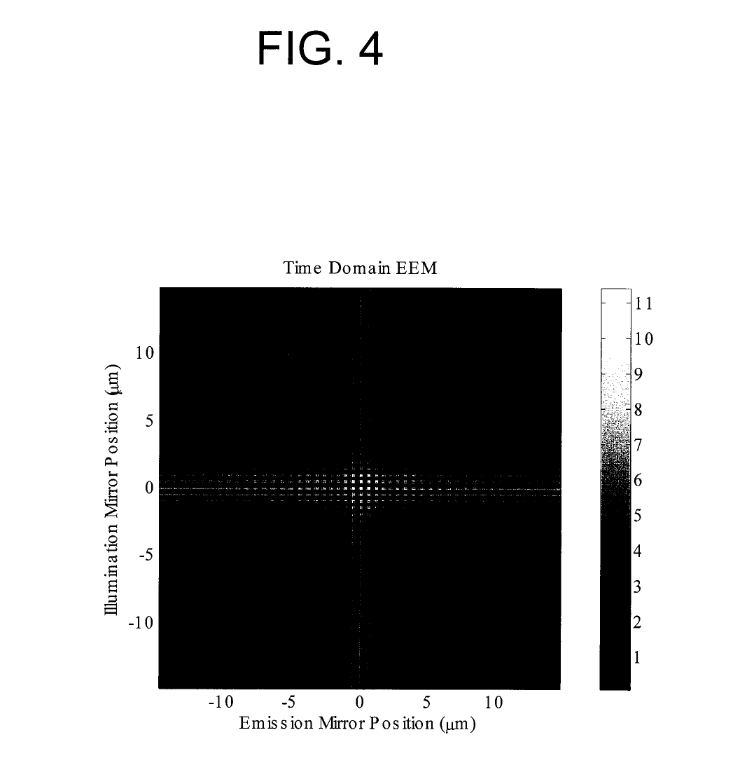

A recovery of the entire I-EEM uses scanning of enough combinations of the variable mirror positions or mirror velocities, to map out a sufficiently dense and extended TD-EEM such that the spectral I-EEM has the appropriate range and resolution. FIG. 4 shows an exemplary simulated TD-EEM for two fluorophores with overlapping excitation spectra and distinct emission spectra. This exemplary simulation can be conducted with, e.g., double-sided interferograms, assuming spatial symmetry for mirror scanning.

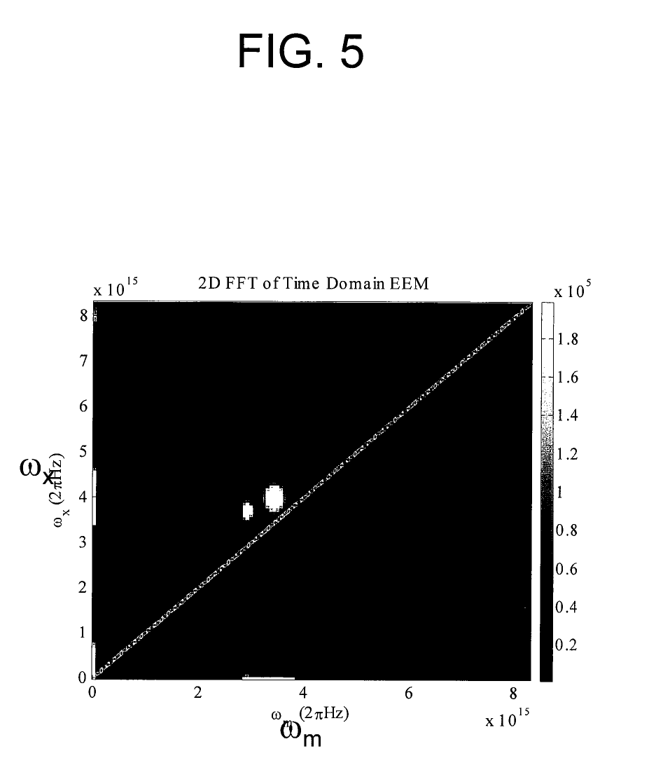

FIG. 4 shows an exemplary image of illumination mirror position (um) versus emission mirror position for a simulated time-domain EEM for two fluorophores with overlapping excitation spectra and different emission spectra. FIG. 5 shows an exemplary image in which the magnitude of the two-dimensional Fourier transform of FIG. 4 can be determined and normalized by the source excitation spectrum (SI(kₓ)) so as to recover the I-EEM. For example, ωᵢ=2πƒᵢ, is the optical frequency of component spectrum i). FIG. 5 illustrates an exemplary graph of ωₓ vs ω^{m} for recovered I-EEM of two fluorophores with overlapping excitation spectra and unique emission spectra. The features of the EEM can be contained within the space where ω_{X}>ω_{M} , since all fluorescence may be emitted with a Stokes shift (e.g., with wavelengths longer than the excitation light).

FIG. 6 shows an exemplary embodiment of a Michelson interferometer 600 which can receives light 601 from a light source 600 at an input port of a modulator 605. The modulator 605 may be a high-frequency modulator and can be either an electro or an acousto-optical modulator. The light 601 may, for example, correspond to light emitted by the source 100 for the first interferometer 105 shown in FIG. 1 and/or the light 601 may correspond to the fluorescence emission 125 for the second interferometer 145 shown in FIG. 1.

An output port of the modulator 605 can lead to a beam splitter 615 which may be provided so as to define light paths 615a, 615b, 615c, 615d. A compensator 620 and a stationary mirror 625 may be provided in a light path 615d defined by the beam splitter 615. A scanning mirror 630 is disposed in a light path 615c also defined by the beam splitter 615. In operation, the light 601 propagating along path 615a can be incident on the beam splitter 615. The beam splitter 615 can direct at least one portion of the light along path 615d toward the compensator 620 and the stationary mirror 625. The beam splitter 615 may direct another portion of the light along path 615c toward the scanning mirror 630. Each of the mirrors 625, 630 can reflect light back toward the beam splitter 615 along respective paths 615c, 615d. The reflected light can return to the beam splitter 615 and may be combined to exit the interferometer along path 615b as a spectrally modulated light 635.

The light 635 may correspond, for example, to light 120 in FIG. 1 (e.g., the light which is emitted from the interferometer 145 and incident upon the sample 125 in FIG. 1). Alternatively, the light 635 may correspond, for example, to light 147 in FIG. 1 (e.g., the light which is emitted from the interferometer 145 and which is incident upon the detector 150 in FIG. 1). The high-frequency modulator 605 (e.g., of either the electro-optical, acousto-optical, or other type)can produce the high-frequency modulated light for detection of rapid decay fluorescence lifetimes. The compensator 620 can correct for dispersion the differences in the arms.

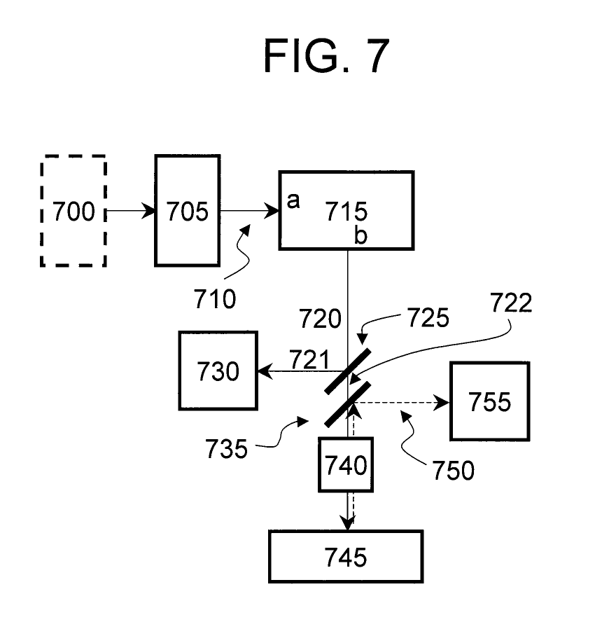

Excitation spectrum measurement by the Fourier transform interferometer is described in J. G. Hirschberg et al., “Interferometric measurement of fluorescence excitation spectra”, Appl. Opt. 37(10), 1953 (1998). The exemplary embodiment of the method according to the present invention is capable of measuring excitation and lifetime spectra simultaneously. Excitation spectra may be obtained by holding the path length difference between the second interferometer reference and sample arms fixed in time or by eliminating the second interferometer, and replacing it with a detector. FIG. 7 shows a block diagram of a system for obtaining the fluorescence excitation spectra and fluorescence lifetimes according to another exemplary embodiment of the present invention.

For example, FIG. 7 shows such exemplary embodiment of the system for obtaining fluorescence excitation spectra and fluorescence lifetimes. Such exemplary system can include a modulator 705 which may be disposed in a light path to receive light 710 from a light source 700 propagating toward a first port 715a of a Michelson interferometer 715. The light source 700 may be internal or external to the exemplary system, and the modulator 705 can be optional.

A beam pick-off 725 can be disposed to intercept light 720 from a second port 715b of the Michelson interferometer 715. The beam pick-off 725 may be provided, for example, from a glass plate. An illumination detector 730 may be disposed in a first light path 721 formed by the beam pick-off 725. The illumination detector 730 may be provided, for example, as a photomultiplier tube (PMT), an avalanche photodiode (APD), a charge coupled device (CCD) detector, a silicon photodiode, and/or the like. A dichroic filter 735 can be disposed in a second light path formed by the beam pick-off 725. Focusing and collecting optics 740 may be disposed between the filter 735 and a sample 745 containing fluorescent material. A fluorescence detector 755 can be disposed in a light path 750 formed by the dichroic filter 735.

In operation, the illumination light provided by the light source 700 may be optionally incident upon the high-frequency modulator 705 to create the high-frequency modulated light 710. Either the light generated by the light source 700 or the modulated light 710 can enter the Michelson interferometer 715 to produce the spectrally modulated light 720. The light 720 can be split by the beam pick-off 725. A portion 721 of the light 720 can be directed toward the reference illumination detector 730. The remaining portion 722 of the modulated light 720 can propagate through the dichroic filter 735 and through the focusing and collecting optics 740. The focusing and collecting optics 740 can focus the light onto the sample 745. The sample 745 can contain a fluorescent material. In response to the light incident on the sample, fluorescence is excited and fluorescent light 750 is emitted from the sample 745. The fluorescent light 750 can be collected by the optics 740 and is directed toward the fluorescence detector 755 by the dichroic 735. The fluorescence detector 755 may be the approximately same as or similar to the detector 730.

In such exemplary case, Equation 5 can reduced the signal detected by the detector 755 as follows:
I′_{f}(t)=∫S_{I}(k_{X})EEM(k_{X},k_{M}){1+cos [2k_{X}z_{X}(t)−φ(k_{X}, k_{M})]}∂k_{X} (6)

Assuming that the phase shift is negligible, Fourier transformation of Equation 6, normalized by the source excitation spectra, S_{I}(k_{X}), can provide the determination of the intensity excitation spectra, as follows:
S_{X}(k_{X})∫EEM(k_{X}, k_{M})∂k_{M}. (7)

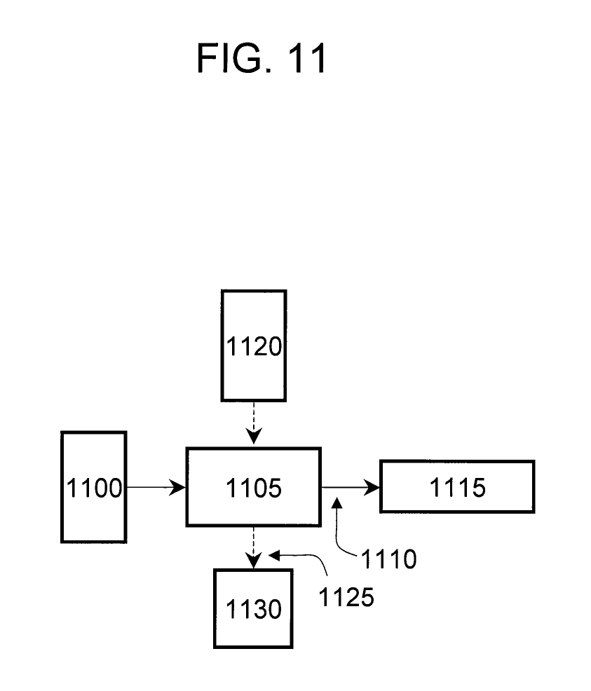

An independent determination of the source spectrum, S_{I}(k_{X}), through detection of the light 720 by the detector 730 and Fourier transform of the reference illumination signal (Eq. 1) can be performed to obtain the excitation spectrum. Additionally, in practice, a second reference light can be used in order to compensate for time-dependent non-linearities in the Z_{X}(t) motion (as described herein with referenced to FIG. 11).

Similar to the excitation spectra measurement and the description of FIG. 7, the lifetime spectra as a function of the excitation wavelength may be obtained by holding the path length difference between the second interferometer reference and sample arms fixed in time and/or by eliminating the second interferometer and replacing it with a detector. In such case, the phase shift of Equation 6 may not necessarily be negligible. The difference in the unwrapped phase measurements as determined by Fourier transform, of the emitted fluorescence (Eq. 6) and the reference illumination (Eq. 1) can determine the excitation lifetime spectrum via Eq. 4, where φk_{X},k_{M})=φ(k_{X},k_{M})−φ(k_{I}). For long-lived fluorescence, the Michelson interferometer may be sufficient to produce the preferable modulation frequencies. The determination of short-lived fluorescence lifetimes may possibly use the high-frequency modulator 705, which may comprise an electro-optic or acousto-optic modulator.

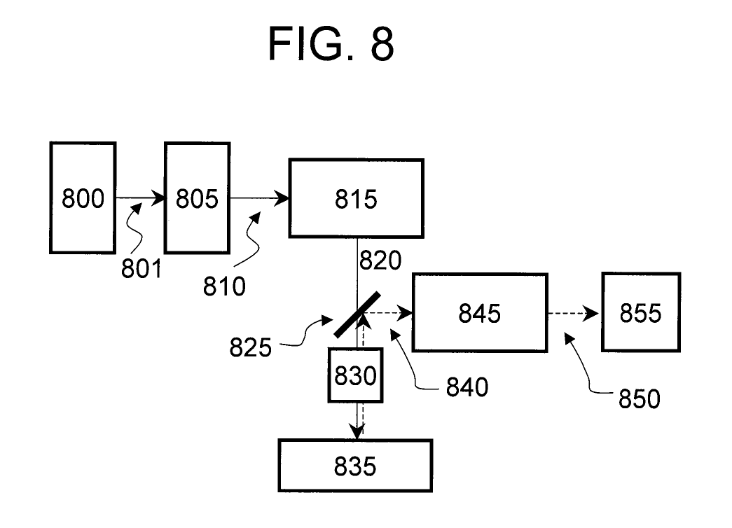

Provided below, in conjunction with the description of the exemplary embodiments shown in FIG. 8-20, is a description of an exemplary embodiment of the method for measuring intensity and lifetime excitation-emission matrixes according to the present invention.

For example, FIG. 8 shows an exemplary embodiment of a system for measuring emission spectra which can include an optional modulator 805 provided to intercept light 801 from a light source 800. An interferometer 815 can be situated to intercept the light 810 (or light 801 in the case in which modulator 805 is not used). A dichroic beamsplitter 825 can be disposed to intercept light from the interferometer 815 and to direct light toward collection optics 830. The collection optics can focus the light onto a fluorescent sample 835.

A scanning Michelson interferometer 845 can be situated to intercept light 840 directed thereto from the dichroic beamsplitter 825 and a fluorescence detector 855, which is disposed to intercept light 850 from the interferometer 845. The detector 855 may preferably be photomultiplier tube (PMT) and/or may alternatively be provided as an avalanche photodiode (APD), a CCD detector, a silicon photodiode or the like. The emission spectra can be obtained by holding a path length difference between the first interferometer reference and sample arms fixed in time. The emission spectra can also be obtained by eliminating the first interferometer 805 and focusing the illumination light directly onto the sample.

In operation of the exemplary system of FIG. 8, the illumination light 800 can optionally be passed through the high-frequency modulator 805 to produce the modulated light 810 having a high modulation frequency. The light 810 (or light 801 in the case when the modulator 805 is not used) may then be passed through the interferometer 815 with the scanning mirror held fixed in time. The light 820 can exits the interferometer 815, and then passes through dichroic beamsplitter 825 to focusing and collection optics 830 and focused onto the fluorescent sample 835. Alternatively, when the interferometer 815 is omitted, the light 810 passes through the dichroic beamsplitter 825 to the focusing and collection optics 830, and focused onto the fluorescent sample 835. In another variant, when both the modulator 805 and the interferometer 815 are omitted, the light 801 can pass through the dichroic beamsplitter 825 to the focusing and collection optics 830, and focused onto the fluorescent sample 835.

In response to the light impinging upon the sample 835, the sample 835 can emit fluorescence which may be collected by the optics 830, deflected by the dichroic 825, and directed into the scanning Michelson interferometer 845. The spectrally modulated fluorescence 850 may then be detected by the fluorescence detector 855. The fluorescence emission 840 may be modulated by the interferometer 845 to produce the spectrally modulated fluorescence signal 850. The intensity of signal 850 may be determined as follows:
I′″_{f}(t)=∫∫S_{I}(k_{X})EEM(k_{X}, k_{M})∂k_{X}{1+cos [2k_{M}z_{M}(t)]}∂k_{M}· (8)

The fluorescence emission spectrum
S_{M}(k_{M})∫EEM(k_{X}, k_{M})∂k_{X}, (9)
may be recovered directly by from the intensity of the Fourier transform of Eq. 8. Additionally, in practice, a second reference light should be used in order to compensate for time-dependent non-linearities in the Z_{M}(t) motion (as described below with reference to FIG. 11).

In certain exemplary embodiments, the light which passes through the dichroic beamsplitter 825 (and which is directed toward the focusing and collection optics 830 and is focused onto the fluorescent sample 835) may correspond to the light 800 or the light 805 (rather than corresponding to the light 820 from the interferometer). Fluorescence can be emitted and collected by the optics 830, deflected by the dichroic 825, and directed into the scanning Michelson interferometer 845. The spectrally modulated fluorescence 850 can then be detected by the fluorescence detector 855.

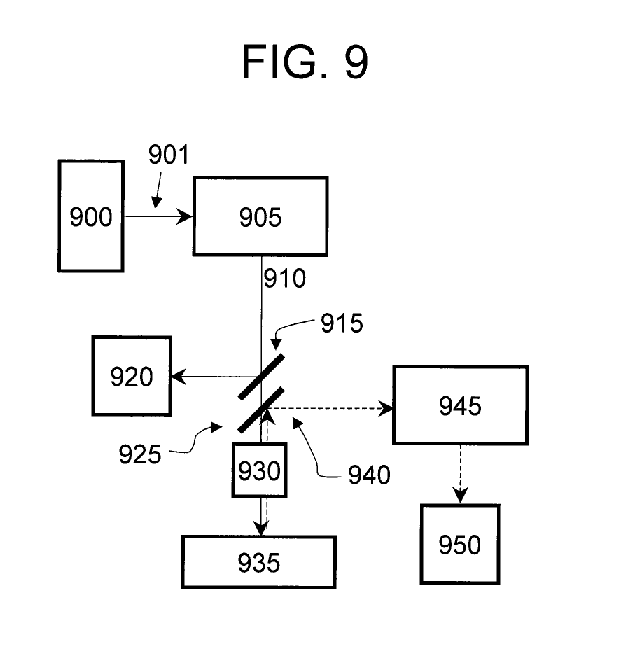

FIG. 9 shows a block diagram of an exemplary embodiment of a system for obtaining I-EEM which can include a light source 900 that provides a light signal 901. An interferometer 905 can be disposed to intercept the light 901. The interferometer 905 may be provided as a Michelson interferometer. The interferometer 905 can generate a spectrally modulated light 910, at least a portion of which may be directed toward a beam pick-off 915 which can direct a first portion of the light incident thereon to an illumination detector 920 and a second portion of the light toward a dichroic 925.

Collecting optics 930 can be situated to intercept light which passes through the dichroic 925. The optics 930 can collect and focus the light onto a sample 935. An interferometer 945, preferably a Michelson interferometer, may be disposed to collect fluorescence emitted by the sample and directed toward the interferometer 945 via the optics 930 and the dichroic 925. Light exiting the interferometer 945 may be detected by a fluorescence detector 950. Additionally, in practice, a second reference light should be used to compensate for time-dependent non-linearities in the Z_{XIM}(t) motion (as described below with reference to FIG. 11).

In operation, the illumination light 900 can be directed through the Michelson interferometer 905 to produce the spectrally modulated light 910. A portion of the light 910 can be deflected by the beam pick-off 915 to the reference illumination detector 920. The remaining portion of the illumination light 910 can pass through the dichroic 925 into the focusing and collecting optics 930 to excite the fluorescence in sample 935. Fluorescence is emitted and collected by the optics 930 and deflected by the dichroic 925 into the Michelson interferometer 945. Light exiting the interferometer 945 is detected by the fluorescence detector 950. Additionally, in practice, a second reference light is required in order to compensate for time-dependent non-linearities in the Z_{XIM}(t) motion (as described below with reference to FIG. 11).

The fluorescence signal detected by the fluorescence detector 950 has the form of Eq. 5. The intensity EEM can be determined from the magnitude of the two-dimensional Fourier transform of the signal from the fluorescence detector 950 and/or from the Fourier transform accompanied by other appropriate mathematics such as the Radon transform (e.g., as described below), normalized by the Fourier transform of the reference illumination spectrum from the detector 920:

$$EEM ( {k}_{X} , {k}_{M} ) = \frac{\vert {𝒥}^{2} [ {I}_{f}^{″} ( t ) ] \vert}{\vert 𝒥 [ {I}_{I} ( t ) ] \vert} . \qquad ( 10 )$$

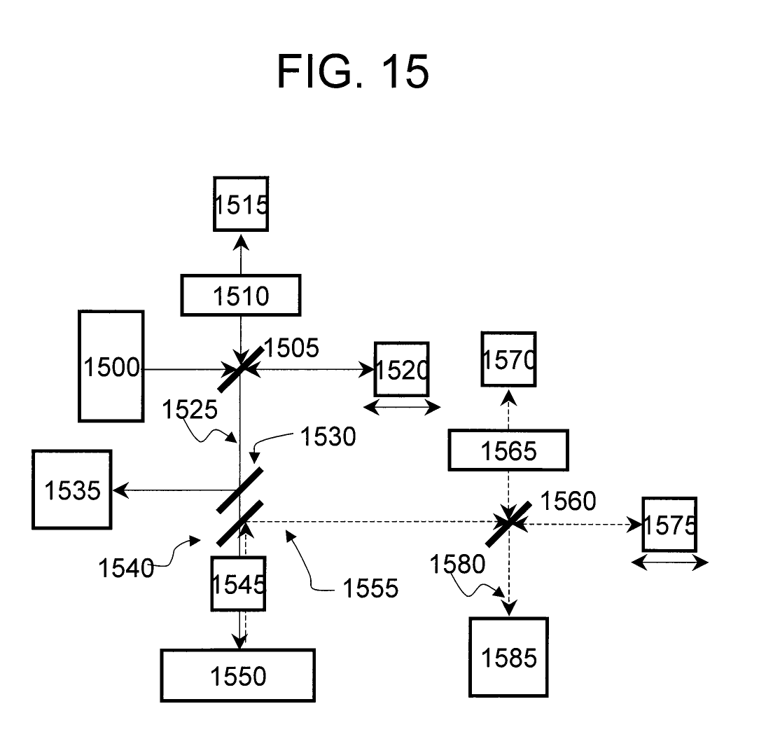

A first exemplary embodiment of the system according to the present invention for determining the EEM involves the use of two Michelson interferometers, both of which have continuous scanning (as shown in FIG. 15). With this exemplary embodiment, the relative velocities of the scanning mirror in the two interferometers can be varied from one scan to another to cover the TD-EEM space in an angular fashion. In such case, some form of back-projection reconstruction technique, such as the Radon transform (as described herein) should be utilized in conjunction with the Fourier transform to recover I-EEM.

A second exemplary embodiment of the system according to the present invention can use a continuously scanning mirror in the first interferometer and a step scanning mirror in the second interferometer (as shown in FIG. 15). In this manner, the TD-EEM can be collected in a linear manner and the Fourier transform is appropriate.

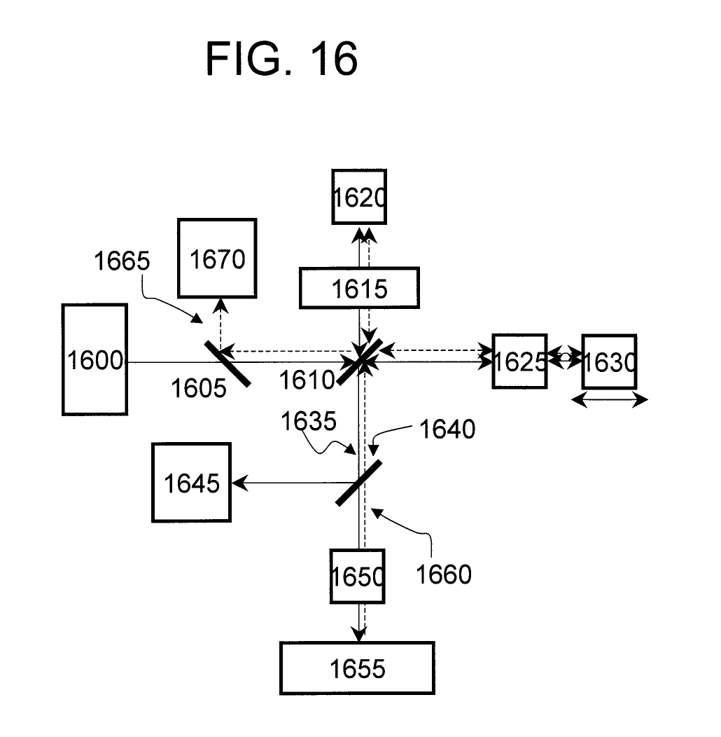

A third exemplary embodiment of the system according to the present invention can use a single interferometer with a multi bounce element and a continuous scanning mirror (as shown in FIG. 16). Similar to the first exemplary embodiment described above, some form of back-projection reconstruction technique, such as the Radon transform (as described below) should be used in conjunction with the Fourier transform to recover I-EEM.

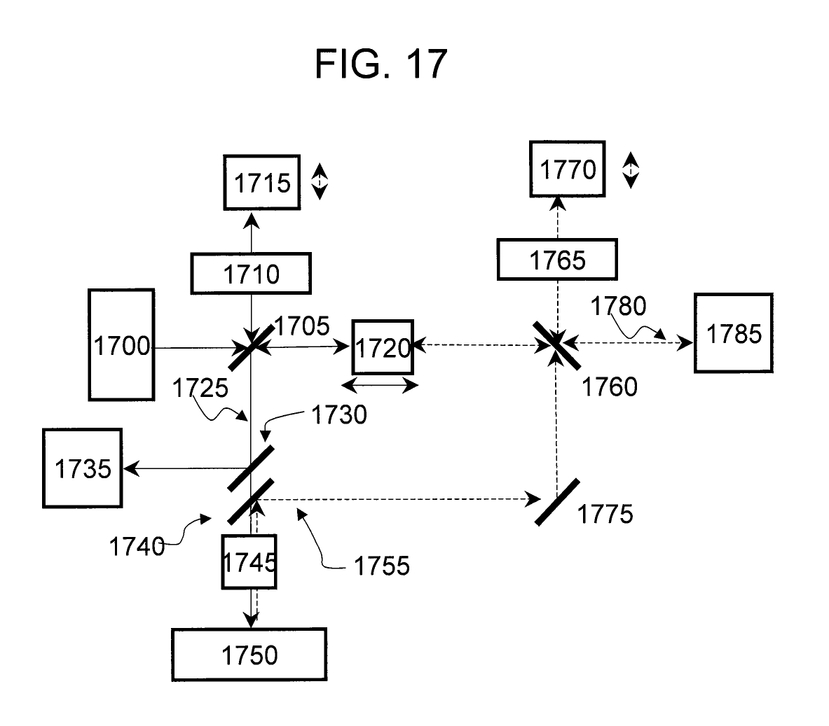

A fourth exemplary embodiment of the system according to the present invention can utilize a continuously scanning double-sided mirror, whose one side serves in the first interferometer and the other side serves in the second interferometer (as shown in FIG. 17). The second interferometer can also have a step scanning mirror on the reference arm. The TD-EEM may be collected as a series of diagonal projections with shifting path offsets between the first and second interferometers.

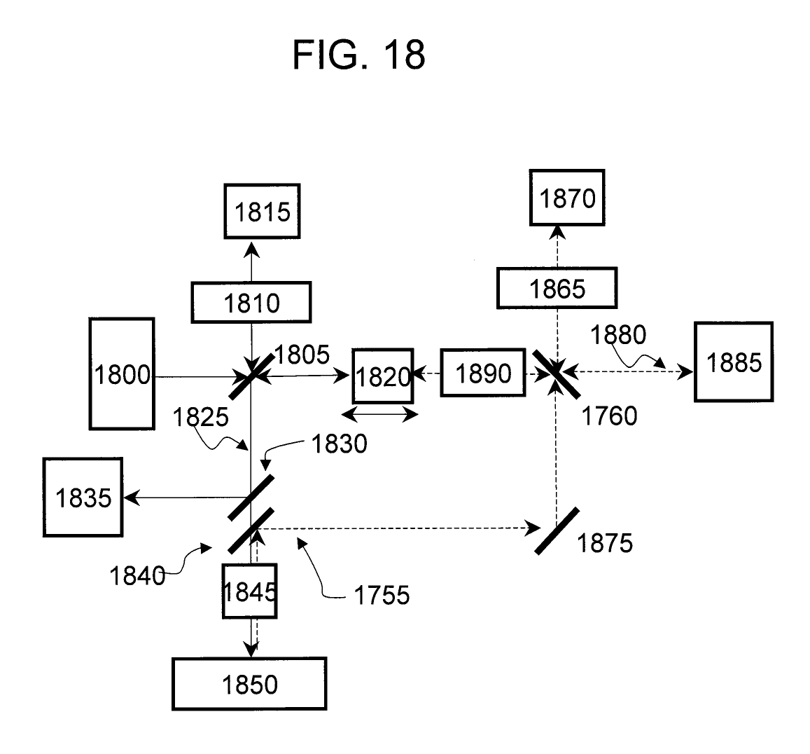

According to a variant of the fourth exemplary embodiment, the continuously scanning double-sided mirror and the multi bounce element in two interferometers can be used (as shown in FIG. 18). Similar to the first and third exemplary embodiments, some form of back-projection reconstruction technique, such as the Radon transform (below) can be used in conjunction with the Fourier transform to recover I-EEM.

In a first exemplary embodiment of the scanning interferometer arrangement according to the present invention, various angular projections of the EEM may be obtained by varying the relative velocities of the two scanning mirrors. For a given maximum scan velocity (vₘₐₓ) and scan angle (θ), let the excitation (first interferometer) scanning mirror position vary as Z_{X}(t)=Vₘₐₓ cos(θ)t, and the emission (second interferometer) scanning mirror position vary as Z_{M}(t)=Vₘₐₓ sin(θ)t. This may result in a unique interferogram for each angle as θ is varied from 0 to π. The angular projections of the EEM (e.g., Fourier transforms of the individual interferograms) are then re-interpolated (see description of Radon transform as provided below) to reconstruct the projections in the desired rectilinear space. It may be preferable to set the change in angle (dθ) from scan to scan to be small enough that the EEM has sufficient resolution for the system of interest.

In the exemplary variant of one interferometer with a continuously scanning mirror and a second interferometer with a step scanning mirror, the TD-EEM space can be automatically mapped out in a rectilinear fashion, therefore the projections of the EEM may be naturally determined via Fourier transform in rectilinear space.

In the exemplary variant of a continuously scanning double-sided mirror that serves both interferometer and a step scanning mirror in the second interferometer, the TD-EEM space can be automatically mapped out in a diagonally-stretch rectilinear fashion, therefore the projections of the EEM may be determined via Fourier transform in rectilinear space followed by a diagonal shift.

Depending upon the method used to map out the TD-EEM, various mathematical transformations may be used to reconstruct the EEM. As described above, when employing one continuously scanning interferometer and one step scanning interferometer, the TD-EEM may be reconstructed via the two-dimensional Fourier transform. If two continuously scanning mirrors are used, then the TD-EEM can preferentially be mapped out by varying relative velocities of the mirrors, and the TD-EEM space may be mapped out with equal angular spacing.

In such case, the EEM can be preferably reconstructed with as follows. The one dimensional Fourier transform of each combination of mirror velocities (e.g., each angle in the TD-EEM) can be taken to map out an angular EEM through each of these angular projections. The EEM may then be reconstructed from the angular EEM using the Radon transform and the known angular values of the projections. Additional methods such as filtered back-projection, two-dimensional interpolation and/or targeted reconstruction can also be used to render the EEM. In addition, there is a priori knowledge, for example, that all values in the EEM for which ω_{X}<ω_{M} are preferably zero (e.g., there may be no anti-Stokes fluorescence emission), which can allow for faster and more accurate constrained reconstructions.

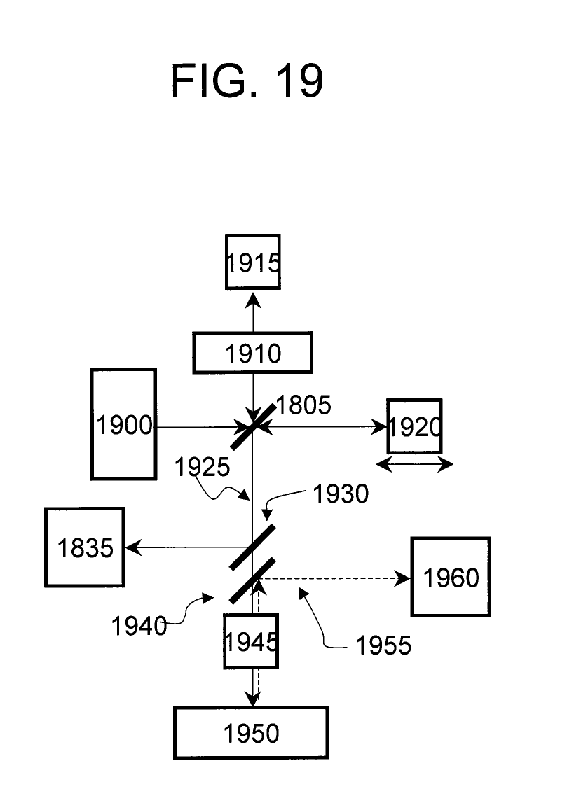

The second interferometer can be replace by a grating based spectrometer that may perform a parallel detection on the modulated emission spectrum (as shown in FIG. 19). I-EEM may be determined by one-dimensional Fourier transform on signals from each emission wavelengths.

The lifetime excitation-emission measurement (L-EEM) can be collected with the exemplary instrumentation which may be similar to that obtained for the I-EEM, and shown in FIG. 9. In this exemplary case, the lifetime may be determined using Eq. 4 where φ(k_{X}, k_{M}=φ(k_{X}, k_{M}−φ(k_{I}). For long-lived fluorescence, the Michelson interferometer may be sufficient to produce the preferable modulation frequencies.

Determination of short-lived fluorescence lifetimes may possibly require a high-frequency modulator similar to the modulator 705 of FIG. 7. Again, as with the I-EEM, various scanning methods can be used. The reconstruction can employ the Hilbert transform in order to place the data in quadrature. Back-projection reconstruction technique apply as described above with reference to the I-EEM.

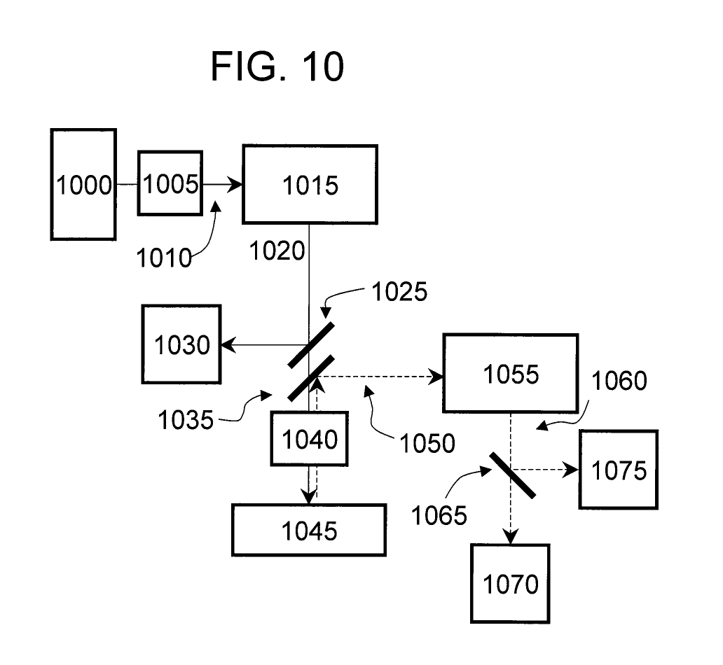

An anisotropy excitation-emission measurement (A-EEM) can be recovered using an exemplary embodiment of a system that is similar to the exemplary system which can be used for measuring the I-EEM and L-EEM, with several additions that are shown in FIG. 10. In particular, FIG. 10 shows an exemplary embodiment of a system for performing an anisotropy excitation-emission measurement (A-EEM), which can include a polarizer, two Michelson interferometers, a polarizing beamsplitter and two fluorescence detectors. An first interferometer 1015 can be disposed to intercept the polarized light 1010. The interferometer 1015 may be provided as a Michelson interferometer. The interferometer 1015 can generate a spectrally modulated light 1020, at least a portion of which may be directed toward a beam pick-off 1025 which can direct a first portion of the light incident thereon to an illumination detector 1030 and a second portion of the light toward a dichroic 1035. Collecting optics 1040 can be situated to intercept light, which passes through the dichroic 1035. The optics 1040 can collect and focus the light onto a sample 1045. An second interferometer 1055, preferably a Michelson interferometer, may be disposed to collect fluorescence emitted by the sample and directed toward the interferometer 1055 via the optics 1040 and the dichroic 1035.

The modifications can be performed by the exemplary system of FIG. 10 as follows. A linear polarizer 1005 may be used to polarize an illumination light 1000. A spectrally modulated fluorescent light 1060 from a second interferometer 1055 can be split into two orthogonal linear polarizations thereof, one parallel to the orientation of 1005, the other perpendicular to the orientation of 1005, for the detection by two fluorescence detectors 1070, 1075, one for each polarization state. The ratio of the modulation depths (m) for each illumination, emission wavelength and polarization can then be determined as follows:

$$Λ ( {k}_{X} , {k}_{M} ) = \frac{{m}_{P} ( {k}_{X} , {k}_{M} )}{{m}_{⊥} ( {k}_{X} , {k}_{M} )} . \qquad ( 11 )$$

The anisotropy may then be determined as follows:

$$r ( {k}_{X} , {k}_{M} ) = \frac{Λ ( {k}_{X} , {k}_{M} ) - 1}{Λ ( {k}_{X} , {k}_{M} ) + 2} . \qquad ( 12 )$$

Alternatively, the I-EEM may be determined for each of the polarization as described above, such that it is possible to obtain EEM_{P} and EEM₁₉₅ for the signals recovered from the fluorescence detectors receiving light parallel to and perpendicular to the illumination light polarization, respectively. The fluorescence A-EEM may then be determined as follows:

$$r ( {k}_{X} , {k}_{M} ) = \frac{{EEM}_{P} - {EEM}_{⊥}}{{EEM}_{P} + 2 {EEM}_{⊥}} . \qquad ( 13 )$$

When combined with measurements of L-EEM, it is possible to obtain r(τ(k_{X}, k_{M}), the lifetime-resolved anisotropy, thus facilitating the analysis of a collisional quenching. This further feature can benefit from the advantages that normal lifetime measurements have over pure intensity measurements.

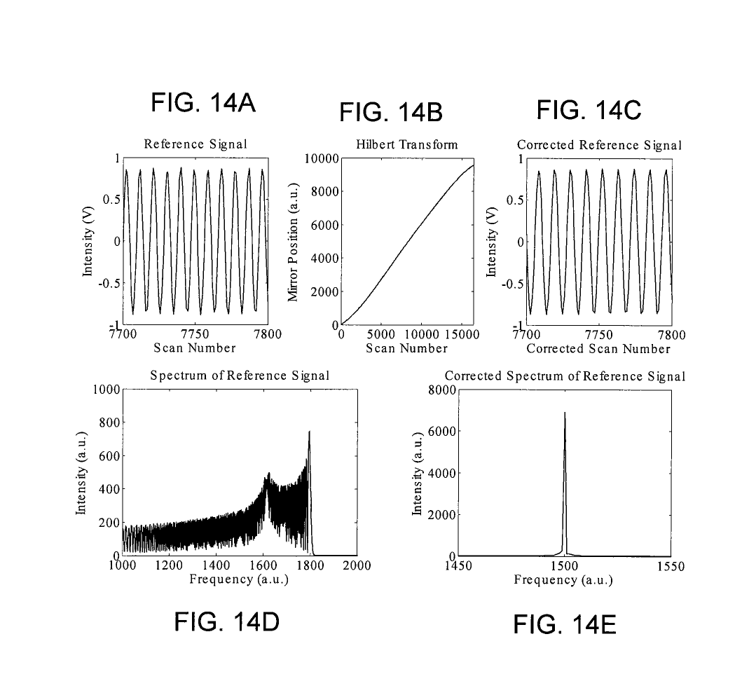

FIG. 11 shows a block diagram of an exemplary embodiment of a system for obtaining a reference measurement to correct for non-linear motion of the scanning mirror in a Michelson interferometer. As shown in FIG. 11, the interferometer 1105 can receive a single frequency light 1125 in additional to the broadband illumination from 1100. A spectra modulated broadband illumination 1110 can be transmitted towards the sample and the illumination detector which is described above with reference to FIGS. 7, 9 and 10. The reference detector 1130 can monitor the interference signal from 1125, which can be used to correct the non-linear motion as described herein with reference to FIG. 14.

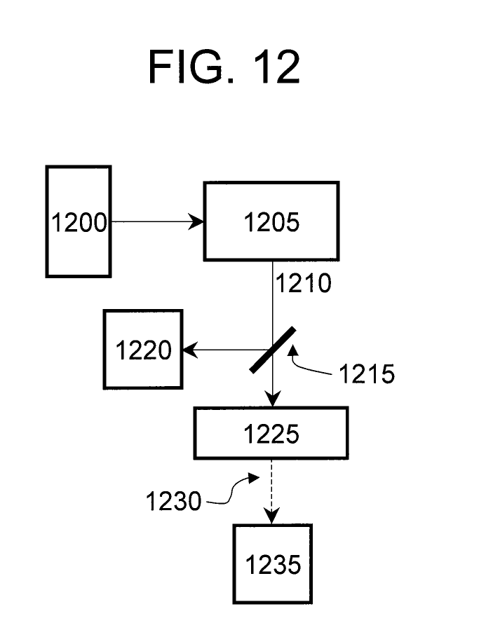

FIG. 12 shows the block diagram of a conventional arrangement for obtaining absorbance spectral measurements, including a light source 1200, a Michelson interferometer 1205, a beam pickoff 1215, a reference illumination detector 1220, an sample 1225 and a transmission detector 1235. Spectral encoded light 1210 passes through 1215 and the sample 1225. Transmitted light 1230 is detected by the detector 1235.

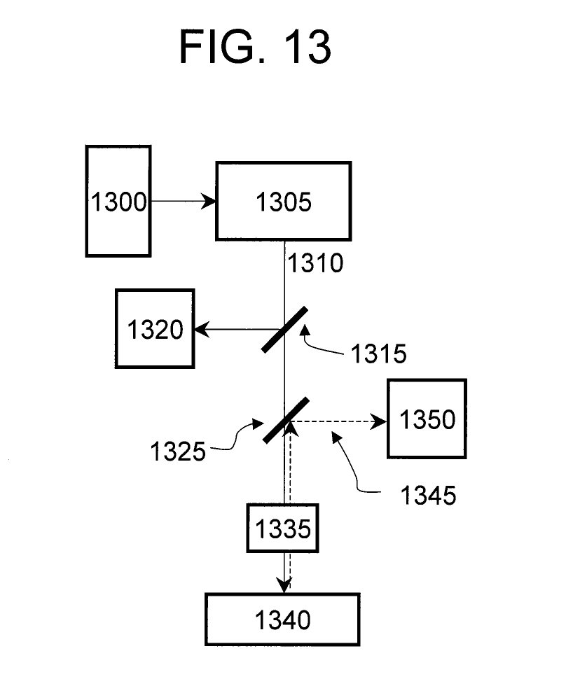

FIG. 13 shows a block diagram of an exemplary embodiment of a system for obtaining diffuse reflectance, which can include a light source 1300, a Michelson interferometer 1305, a beam pickoff 1315, a beamsplitter 1325, an objective 1335, a reference illumination detector 1320, and a reflectance detector 1350. Spectral encoded light 1310 is focused onto the sample 1340 by the objective 1335. Reflected light 1345 is detected by the detector 1350.

FIGS. 14A-14E show graphs which, when considered in conjunction with one another, may illustrate the effects of the spectral algorithm used to correct signals for non-linear motion of the scanning mirror in the Michelson interferometers. In particular, FIG. 14A shows an exemplary graph of intensity versus scan number for a reference signal. FIG. 14B shows an exemplary graph of mirror position versus scan number. FIG. 14C shows an exemplary graph of intensity versus corrected scan number for a corrected reference signal. FIG. 14D shows an exemplary graph of intensity versus frequency for a reference signal. FIG. 14E shows an exemplary graph of intensity versus frequency for a corrected reference signal.

FIG. 15 shows a block diagram of an exemplary embodiment of a system according to the present invention which uses two Michelson interferometers. The light form the light source 1500 is sent into the first interferometer, which consists a station mirror 1515, a translatable mirror 1520, a beam splitter 1505 and a compensator 1510. Spectral encoded light 1525 pass through a beam pickoff 1530, a dichroic filter 1540 and an objective 1545. A portion of 1525 is detected by the reference detector 1535. The objective focuses 1525 onto the sample and collects emitted fluorescence light 1555. Light 1555 is sent into a second interferometer by the dichroic filter. The second interferometer, similar to the first interferometer, consists of a station mirror 1570, a translatable mirror 1575, a beam splitter 1560 and a compensator 1565. Spectral modulated emission light 1585 is detected by the detector 1585.

FIG. 16 shows a block diagram of an exemplary embodiment of a system according to the present invention, which uses multiple passes of a single scanning interferometer by including a multi bounce element, such as an etalon. The system includes a light source 1600, a dichroic filter 1665, an emission detector 1670, a interferometer, which has a beam splitter 1610, a station mirror 1620 and a compensator 1615 on one arm, and a translatable mirror 1630 and a multiple pass element 1625 on the other arm. Spectral encoded illumination 1635 passes through a beam pickoff 1640. A portion of 1635 is bounces off 1640 and detected by the reference detector 1645. The objective 165o focus illumination light onto the sample 1655, and collects fluorescence emission. Emission 1640 is sent back to the interferometer to be further modulated. The spectral modulated emission 1665 bounces off the dichroic filter 1605 and is detected by the emission detector 1670.

FIG. 17 shows a block diagram of an exemplary embodiment of a system according to the present invention which uses a double-sided mirror as the sharing moving element of two Michelson interferometers and an additional step scan mirror in the first or second interferometer. Both interferometers consist a station mirror (1715 or 1770), a compensator (1710 or 1770) and a beamsplitter (1705 or 1760). The two interferometer share a same translatable element, a double side mirror, whose each side is used by one interferometer. The first interferometer spectral encodes the light from the light source 1700. Spectral encoded light 1725 is delivered to the sample 1750 thougth a beam pickup 1730, a dichroic filter 1740 and an objective 1745. The reference detector 1735 monitors the light 1725. Emission from the sample 1755 is sent into the second interferometer. The emission detector 1785 detects the spectral modulated emission 1780.

FIG. 18 shows a block diagram of an exemplary embodiment of a system according to the present invention which uses a double-sided mirror as the sharing moving element of two Michelson interferometers and a multi bounce element in one of the two interferometers. The system is same as the system shown in FIG. 17,except a multiple bounce element 1890 is added into the second interferometer.

FIG. 19 shows a block diagram of an exemplary embodiment of a system according to the present invention which utilizes a single interferometer and a spectrometer. The system is same as the system shown in FIG. 9, except the interferometer 940 and the detector 950 in FIG. 9 is replaced by a spectrometer 1960.

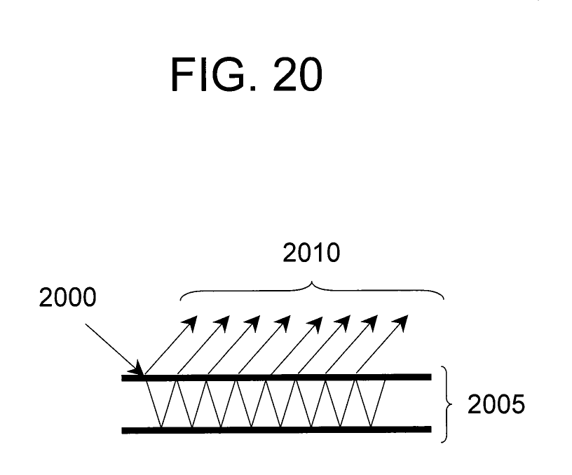

FIG. 20 shows a block diagram of an exemplary embodiment of an etalon beamsplitter system for multiple passing the scanning interferometer. 2000 is the incident light, 2005 is the etalon, and 2010 is a series of reflected light created by multiple bounces.

Provided below, in conjunction with the description and references to FIGS. 21-23, is a description of exemplary modifications for an exemplary embodiment of a system for measuring short lifetimes.

The minimal lifetime that the exemplary embodiment of the system can detect may be limited by the maximum modulation frequency that the source can provide. For a long lifetime fluorescence, a modulation from scanning the Michelson interferometer can be used. For a short lifetime fluorescence, a higher frequency modulation should be used. A 100-MHz frequency modulation in the source can enable the exemplary system to detect nanosecond lifetime. High frequency intensity modulation can be achieved by using an electro or acoustic optical modulator with a constant intensity source, an intensity modulated source such as a LED with modulated bias, and/or a pulsed light source whose intensity output contains multiple harmonics that can be as high as in GHz. The fast intensity modulation at frequency in the illumination, excitation and emission can be detected by cross-correlating the light intensity with a detection gain modulated at f+df, which decreases the carrier frequency to a low frequency df for digitization and real-time or offline analyze. The modulation of detection gain can be achieved by a second modulator in front of the detector and/or a detector whose gain can be directly modulated by a high frequency signal, such as a photomultiplier tube (PMT) or a CCD detector with a modulated intensifier.

Additional exemplary modifications after the light source and before the fluorescence detector should be employed for short lifetime excitation-emission measurement. Referring FIGS. 21-23, exemplary possible modifications may be as follows.

For example, FIG. 21 shows a block diagram of an exemplary embodiment of the system according to the present invention which can use modulators for source intensity and detection gain modulation. Light emitted by a continuous light source 2100 can be modulated at a high frequency by an electro or acoustic modulator 2105. The modulated light 2106 may be transmitted through an exemplary optical system 2110 that may measure L-EEM and/or I-EEM, which can be the exemplary system described above with reference to FIG. 9, without the light source and the fluorescence detector being absent therefrom. The spectral modulated fluorescence light 2110 that exits may be demodulated by a second modulator 2115 to a low frequency. Two RF generators 2120, 2135 can provide driving RF signals for both modulators 2105, 2115. The RF generators 2120, 2135 may be phase locked with each other and have a frequency difference set at df.

FIG. 22 shows a block diagram of another exemplary embodiment of the system according to the present invention which can utilize an intensity modulated LED 2200 and a gain modulated detector 2225. The light from the LED 2200 may be modulated by a RF signal 2250 at f, and the gain of the PMT may be modulated by a RF signal 2255 at f+df. The two RF signals may be provided from RF generators 2230, 2235 that may be phase-locked. Current output of the detector 2225 may be at a low carrier frequency df due to the cross-correlation process.

FIG. 23 shows a block diagram of yet another exemplary embodiment of the system according to the present invention which can use a pulse light source 2300 with a repetition rate f, whose n-th harmonics is at a frequency nf high enough for measuring the short lifetime fluorescence. A small portion of the pulsed light 2350 may be transmitted to a pulse detector 2340. Repetition signals from the pulse detector 2340 may be provided to a frequency synthesizer 2330 as its frequency standard. The frequency synthesizer 2330 may generate a signal 2355 at n*f+df, which modulates the detector gain. Additional exemplary configurations can be implemented by interchanging the source intensity modulation or detection modulation methods and procedures between these exemplary configurations.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004, U.S. patent application Ser. No. 11/266,779, filed Nov. 2, 2005, and U.S. patent aspplication Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. A system for obtaining information associated with at least one portion of a sample, comprising:
at least one arrangement configured to:
i. receive a first radiation and provides at least one second radiation and at least one third radiation as a function of the first radiation,
ii. modulate respective intensities of the second and third radiations, wherein the second and third radiations have different modulation frequencies, and wherein the modulated second and third radiations are directed toward the at least one portion,
iii. receive the photoluminescence radiation from the at least one portion based on the modulated second and third radiations to generate a resultant signal, and
iv. process the signal to obtain the information which is at least one of photoluminescence lifetime characteristics or a polarization anisotropy of the at least one portion.

2. The system according to claim 1, wherein the at least one arrangement contains a particular interferometer arrangement.

3. The system according to claim 2, wherein the particular interferometer arrangement contains at least one path that is translatable.

4. The system according to claim 2, further comprising a further interferometer which is in communication with the particular interferometer.

5. The system according to claim 4, wherein the further interferometer generates a further signal.

6. The system according to claim 5, further comprising a processing arrangement which corrects at least one non-linearity of the signal as a function of the further signal.

7. The system according to claim 1, further comprising at least one detector arrangement which is configured to detect a polarization of the photoluminescence lifetime characteristics.

8. A system for obtaining information associated with at least one portion of a sample, comprising:
at least one first arrangement configured to:
i. receive a first radiation and provides at least one second radiation and at least one third radiation as a function of the first radiation,
ii. modulate respective intensities of the second and third radiations, wherein the second and third radiations have different modulation frequencies, and wherein the modulated second and third radiations are directed toward the at least one portion, and
iii. receive the photoluminescence radiation from the at least one portion based on the modulated second and third radiations; and
at least one second arrangement configured to receive the photoluminescence radiation, and separate the photoluminescence radiation based on wavelengths thereof.

9. The system according to claim 8, wherein the at least one second arrangement includes an interferometer arrangement.

10. The system according to claim 9, wherein the interferometer arrangement contains at least one path that is translatable.

11. The system according to claim 8, wherein the at least one second arrangement includes a grating arrangement.

12. The system according to claim 8, wherein the first and second arrangements each includes an interferometer arrangement.

13. The system according to claim 8, wherein the at least one second arrangement includes a detection arrangement which is configured to perform a parallel detection of spectrum of the photoluminescence radiation.

14. The system according to claim 8, wherein the at least one first arrangement is configured to modulate the spectrum of the photoluminescence radiation.

15. The system according to claim 14, further comprising at least one third arrangement is configured to process the modulated spectrum to generate an intensity excitation emission matrix of the photoluminescence radiation.

16. The system according to claim 15, wherein the at least one first arrangement modifies modulation frequencies of the second and third radiations determine a change in the intensity excitation emission matrix.

17. The system according to claim 16, wherein the at least one third arrangement determines a lifetime excitation emission matrix of the photoluminescence radiation based on the change.

18. The system according to claim 16, wherein the at least one third arrangement determines a polarization anisotropy emission matrix of the photoluminescence radiation based on the change.

19. The system according to claim 8, further comprising a further interferometer arrangement which is in communication with the interferometer arrangement.

20. The system according to claim 19, wherein the further interferometer arrangement is configured to generate a further signal.

21. The system according to claim 20, further comprising a processing arrangement which is configured to correct at least one non-linearity of the signal as a function of the further signal.

22. The system according to claim 8, wherein the at least one second arrangement includes a dispersive arrangement.

23. A method for obtaining information associated with at least one portion of a sample, comprising:
receiving a first radiation and providing at least one second radiation and at least one third radiation as a function of the first radiation;
modulating respective intensities of the second and third radiations, wherein the second and third radiations have different modulation frequencies, and wherein the modulated second and third radiations are directed toward the at least one portion,
receiving the photoluminescence radiation from the at least one portion based on the modulated second and third radiations to generate a resultant signal, and
processing the signal to obtain the information which is at least one of photoluminescence lifetime characteristics or a polarization anisotropy of the at least one portion.

24. A method for obtaining information associated with at least one portion of a sample, comprising:
receiving a first radiation and provides at least one second radiation and at least one third radiation as a function of the first radiation;
modulating respective intensities of the second and third radiations, wherein the second and third radiations have different modulation frequencies, and wherein the modulated second and third radiations are directed toward the at least one portion;
receiving the photoluminescence radiation from the at least one portion based on the modulated second and third radiations;
receiving the photoluminescence radiation; and
separating the photoluminescence radiation based on wavelengths thereof.
